(19) United States
(12) Patent Application Publication
(10) Pub. No.: US 2022/0290374 A1
(43) Pub. Date: Sep. 15, 2022

(54) Grass-Containing Liquid Packaging Board

(71) Applicant: CREAPAPER GmbH, Hennef (DE)

(72) Inventor: Uwe D'AGNONE, Hennef (DE)

(21) Appl. No.: 17/636,723

(22) PCT Filed: Aug. 18, 2020
(86) PCT No.: PCT/EP2020/073099

§ 371 Date: Feb. 18, 2022

(30) Foreign Application Priority Data
Aug. 19, 2019 (DE) 10 2019 122 192.7

(51) Int. Cl. D21H 17/17; B65D 5/40; B65D 65/46; D21F 11/00; D21H 11/12; D21H 11/14; D21H 19/34; D21H 21/10; D21H 27/10

(52) U.S. Cl. CPC D21H 17/17; B65D 5/40; B65D 65/466; D21F 11/00; D21H 11/12; D21H 11/14; D21H 19/34; D21H 21/10; D21H 27/10

(57) ABSTRACT

The method according to the invention for producing a grass fibre-containing liquid packaging board has the following steps, specifically:
providing a fibre suspension formed from at least a first and second pulp type, wherein the first pulp type is constituted by grass fibres, and the second pulp type is selected from a group of pulps which comprises primary fibres such as chemical pulp, for example sulphate pulp or sulphite pulp, in each case based on long-fibre wood or short-fibre wood, wood pulp, and synthetic fibres or recycled fibres based on one or more recycled paper classifications,
mixing and/or swelling the fibres in the pulp suspension under predefined conditions with respect to material density and temperature,
grinding the at least two pulp types together in a pulp suspension to a degree of dewatering between 40° SR and 60° SR,
adding starch and/or a sizing agent as an additive in the mass,
diluting the pulp suspension and producing a board on a paper machine,
surface sizing the board using at least one starch-containing suspension, and
drying the paper structure to a dry content between 4% and 10%.

The present invention relates to a method for producing a grass fibre-containing liquid packaging board, such as a beverage packaging board, and use thereof, for example, for producing a beverage packaging, such as a beverage cup, which in particular can be easily recycled and composted.

Methods for producing beverage packagings are known in the prior art. However, due to the production of the board for example as a composite material, they have the disadvantage that the fibres used herein cannot be reprocessed or can only be reprocessed with difficulty and are usually only suitable for thermal recovery.

The object of the present invention is to at least partly improve the disadvantages known in the prior art and in particular to provide a beverage packaging board which is produced, amongst other things, from grass-containing fibres and on account of its production and/or processing can be used directly as packaging material for liquids such as beverages, and can be easily recycled so that the fibres contained herein can be used again or alternatively can be easily composted.

This object is achieved by the method for producing a liquid packaging board according to claim 1 and the reprocessing or use thereof for the production, for example, of a beverage packaging such as a beverage cup. Preferred embodiments are the subject of the dependent claims.

The method according to the invention for producing a grass fibre-containing liquid packaging board has the following steps, specifically:
providing a fibre suspension formed from at least one first and second pulp type, wherein the first pulp type is constituted by grass fibres and the second pulp type is selected from a group of pulps which comprise primary fibres, such as chemical pulp, for example sulphate pulp or sulphite pulp, in each case based on long-fibre wood or short-fibre wood, wood pulp, and synthetic fibres or recycled fibres based on one or more recycled paper classifications,
mixing and/or swelling the fibres in the pulp suspension under predefined conditions in respect of material density and temperature,
grinding the at least two pulp types together in a predefined pulp suspension between 0.1% and 15% to a degree of dewatering between 40° SR and 70° SR, in particular 40° SR and 60° SR,
adding starch and/or a sizing agent as an additive in the mass,
diluting the pulp suspension and producing a board on a paper machine,
surface sizing the board using at least one starch-containing suspension, and
drying the paper structure to a dry content between 4% and 17%.

The method according to the invention, in accordance with a further embodiment, is characterised in that the pulp suspension, in particular prior to the swelling of the fibres, has a material density between 1% and 10%, in particular between 2% and 8%, and in particular between 3% and 6%.

The proportion of the first pulp type in the finished board, in accordance with a preferred embodiment, lies between more than 0% and less than 100%, preferably between 10% and 50%, and in particular is 30%.

The proportion of the second pulp type in the finished board, in accordance with a preferred embodiment, is accordingly between less than 100% and greater than 0%, preferably between 90% and 50%, and in particular is 70%.

The second pulp type is preferably a mixture of 10% to 60% short-fibre chemical pulp, such as birch, bamboo or bagasse pulp, and 90% to 40% long-fibre pulp, such as spruce or pine sulphate pulp.

In accordance with the invention the mixing and/or the swelling are preferably performed at a predefined material density, which in particular lies in a range between 1% and 10%, over a period of time between 2 minutes and 10 minutes, in particular between 4 and 8 minutes, and preferably at a temperature between 10° C. and 70° C.

The starch used with preference in the present method is a potato, maize or wheat starch, in particular a cationic or anionically modified starch.

In particular, a resin size, preferably reinforced or unreinforced, or a synthetic sizing agent, such as alkyl ketene dimer (AKD), alkenyl succinic anhydride (ASA), stearic acid or fluoroorganic compounds (FC), is used in particular as sizing agent for hydrophobing the cellulose fibres, and is more preferably combined with a natural or synthetic polymer.

The board produced on the paper machine preferably has a mass per unit area between 35 g/m² and 600 g/m², preferably between 250 g/m² and 300 g/m², and in particular, a mass per unit area of 270 g/m².

The surface sizing is performed in particular using at least one starch suspension, wherein the starch suspension in accordance with a further embodiment comprises at least one further additive which is selected from the group comprising carboxymethyl cellulose, glyoxal, polymer sizing agent, dry strength agent, wet strength agent, resin size, and synthetic sizing agents.

The fibres are preferably ground together, however, it is not out of the question that parts of the pulp or pulp types are pre-ground separately. The grinding, in particular the fibrillating grinding, is performed using a grinding machine, such as a Hollander beater with a power of 200 kW, a Papillon Refiner with a power between 100 and 3600 kW, a single-disc refiner, a twin-disc refiner, a twin-refiner, a flat cone crusher, a steep cone crusher with a power between 90 kW and 2800 kW, or a disc mill with a power between 315 kW and 2500 kW. Here, the grinding can be performed continuously or in batches, and individual machines from the aforementioned selection can be combined in a series or a plurality of the same machines can be connected in series.

The objective is to provide the gentlest grinding possible, in which the fibres are shortened only to a limited extent, but nevertheless enlarged in respect of their active surface. This is achieved by what is known as fibrillating grinding, in which the fibres are preferably crushed so that additional binding-active surface regions are provided for the paper or board production. In order to achieve this grinding, a high grinding energy is introduced into the pulp, wherein the pulp then also has to be cooled here between the individual grinding stages as appropriate, or alternatively the material density of the pulp is reduced.

The second pulp is selected from a group of pulps which comprises natural chemical pulps, such as cotton, refiner mechanical pulp (RMP), chemi refiner mechanical pulp (CRMP or CMP) or chemi-thermomechanical pulp (CTMP), pressurised refiner mechanical pulp (PRMP), semi-chemical pulp, high-yield chemical pulp, chemical pulp, alkaline pulp such as sulphate pulp or sulphite pulp, all of the aforementioned pulps as fresh fibres or also as recycled fibres, such as recycled paper preferably of the medium or high grades in accordance with EN 643:2001, group 2 or group 3.

In accordance with a further alternative embodiment of the present invention, the pulp is dispersed prior to the grinding. For the dispersion with a disperser, the individual fibres of the pulp suspension are separated from one another to the greatest possible extent and the fibre surfaces, as appropriate, are also cleaned and/or expanded and foreign particles in the pulp suspension are size-reduced or distributed as uniformly as possible.

In accordance with a further alternative embodiment of the present invention, the board is smoothed in the paper machine and/or offline by means of a calender, for example a soft nip calender, supercalender, multi-nip calender, shoe calender, metal band calender or friction calender, under predefined conditions in respect of the temperature, compressive stress, duration, number of nips, elastic properties of the rollers and the web moisture.

The first pulp type is selected from a group containing spike grasses, meadow grasses and spiked meadow grasses, as well as sedges of the genera Poaceae and Cyperaceae, in particular grasses of the subfamilies Anomochlooideae, Pharoideae, Puelioideae, Bambusoideae Ehrhartoideae, Pooideae, such as Tribus Aveneae, Tribus Poeae, Tribus, Triticeae Aristidoideae, Danthonioideae, Arundinoideae, Chloridoideae, Centothecoideae, Panicoideae, such as Saccharum officinarum and Micrairoideae, and in particular Agrostis canina—velvet bentgrass; Agrostis capillaris—common bent; Agrostis stolonifera—creeping bent; Agrostis vinealis—brown bent; Aira caryophyllea—silver hairgrass; Aira praecox—early hairgrass; Alopecurus geniculatus—water foxtail; Alopecurus myosuroides—slender meadow foxtail; Alopecurus pratensis—meadow foxtail; Ammophila arenaria—marram grass; Anthoxanthum aristatum—awned vernalgrass; Anthoxanthum odoratum—sweet vernalgrass; Apera spica-venti—lose silky-bent; Arrhenatherum elatius—bulbous oat grass; Avena fatua—common wild oat; Avena sativa—common oat; Brachypodium pinnatum—heath false brome; Brachypodium sylvaticum—false brome; Briza maxima—big quaking grass; Briza media—common quaking grass; Bromus arvensis—field brome; Bromus benekenii—Denver brome; Bromus carinatus—California brome—mountain brome; Bromus erectus—erect brome; Bromus hordeaceus—soft brome; Bromus inermis—awnless brome; Bromus mad ritensis—compact brome; Bromus secalinus—rye brome; Bromus sterilis—barren brome; Bromus tectorum—downy brome; Calamagrostis arundinacea—reed grass; Calamagrostis epigejos—wood small-reed; Catapodium rigidum—fern-grass; Coix lacryma-jobi—adlay; Cortaderia selloana—pampas grass; Corynephorus canescens—grey hair-grass; Cynodon dactylon—dog's tooth grass; Cynosurus cristatus—rested dog's tail; Dactylis glomerata—cock's foot; Danthonia decumbens—heath grass; Deschampsia cespitosa—tufted hairgrass; Deschampsia flexuosa—wavy hair-grass; Deschampsia setacea—bog hair-grass; Digitaria ischaemum—smooth crabgrass; Digitaria sanguinalis—purple crabgrass; Echinochloa crus-galli—common barnyard grass; Echinochloa muricata—rough barnyard grass; Elymus caninus—bearded couch; Elymus repens—couch grass; Eragrostis albensis—Elbe lovegrass; Eragrostis curvula—weeping lovegrass; Eragrostis minor—small lovegrass; Eragrostis multicaulis—Japanese lovegrass; Festuca arundinacea—tall fescue; Festuca filiformis—fine-leaf sheep fescue; Festuca gigantea—giant fescue; Festuca pratensis—meadow fescue; Festuca rubra—red fescue; Glyceria fluitans—floating sweet-grass; Glyceria maxima—great manna grass; Glyceria maxima—great manna grass; Helictotrichon pratense—meadow oat-grass; Helictotrichon pubescens—downy oat-grass; Helictotrichon pubescens—downy oat-grass; Holcus lanatus—tufted grass; Hordelymus europaeus—wood-barley; Hordeum jubatum—foxtail barley; Hordeum murinum—wall barley; Hordeum vulgare—common barley; Koeleria macrantha—crested hair-grass; Koeleria pyramidata—prairie Junegrass; Lolium multiflorum—Westerwolds ryegrass; Lolium perenne—perennial ryegrass; Lolium remotum—flaxfield ryegrass; Lolium temulentum—darnel ryegrass; Melica ciliata—hairy melic; Melica nutans—mountain melick; Melica uniflora—wood melick; Milium effusum—wood millet; Miscanthus floridulus—Pacific Island silvergrass; Miscanthus sacchariflorus—Amur silvergrass; Miscanthus sinensis—Chinese silvergrass; Miscanthus sinensis ‘Variegatus’—Chinese silvergrass; Miscanthus sinensis ‘Variegatus’—Chinese silvergrass; Molinia arundinacea—Moor grass; Molinia caerulea—purple moor grass; Nardus stricta—matgrass; Panicum capillare—witchgrass; Panicum miliaceum—proso millet; Panicum riparia—panic grass; Pennisetum setaceum—crimson fountain grass; Pennisetum villosum—feathertop grass; Phalaris arundinacea—reed canary grass; Phalaris canariensis—canary grass; Phleum phleoides—Boehmer's cat's tail; Phleum pratense—timothy grass; Phragmites australis—common reed; Poa annua—annual meadow-grass; Poa bulbosa—bulbous bluegrass; Poa chaixii—broad-leaved meadow-grass; Poa compressa—flattened meadow-grass; Poa nemoralis—wood bluegrass; Poa palustris—fowl bluegrass; Poa pratensis—Kentucky bluegrass; Poa trivialis—rough meadow-grass; Polypogon monspeliensis—annual beard-grass; Puccinellia distans—weeping alkaligrass; Secale cereale—rye; Sclerochloa dura—common hardgrass; Setaria italica—foxtail millet; Setaria pumila—yellow foxtail; Setaria verticillata—hooked bristlegrass; Setaria viridis—green foxtail; Sorghum bicolor—sorghum; Sorghum halepense—Johnson grass; Trisetum flavescens—yellow oatgrass; Triticale; Triticum aestivum—common wheat; Triticum dicoccon—Emmer; Triticum durum—durum wheat; Triticum monoccocum—einkorn wheat; Triticum spelta—dinkel wheat; Vulpia myuros—rat's tail fescue; Zea mays—maize, meadow grass, sport and utility grass, such as Festuca, Lolium perenne, Poa pratensis, Agrosti, sedges of the genus Carex, combinations hereof and the like, and seagrass or algae selected from a group containing Zostera seagrass genera and the species Zostera angustifolia Hornem. Rchb., Zostera asiatica Miki, Zostera caespitosa Miki, Zostera capensis Setch., Zostera capricorni Asch., Zostera caulescens Miki, Zostera japonica Asch. & Graebn., common seagrass Zostera marina L., Zostera mucronata Hartog, Zostera muelleri Irmisch ex Asch., dwarf eelgrass Zostera noltii Hornem., Zostera novazelandica Setch., Zostera tasmanica M. Martens ex Asch., Heterozostera and Phyllospadix, Posidonia Neptune grasses from the Posidoniaceae family, Cymodocea, Halodule, Syringodium and Thalassodendron from the Cymodoceaceae family and Enhalus acoroides, Halophila and Thalassia from the Hydrocharitaceae family, subfamily Halophiloideae, or Glaucophyta, Haptophyta, Cryptista (Cryptophyta), Euglenozoa, Dinozoa s. Dinoflagellates, Raphidophyceae Chloromonadophyceae, Chlorarachniophyta, yellow-green algae Xanthophyceae, golden algae (Chrysophyta), Bacillariophyta diatoms, Phaeophyta brown algae, Rhodophyta red algae, Chlorophyta green algae, Picobiliphyta, Heterokontophyta, Excavata, Stramenopile, Haptophyta, Cryptophyta, Chlorarachniophyta and Heterokontophyta, Alveolata, Biliphyta, combinations hereof and the like.

It is additionally also advantageous to use, as further pulp for the first pulp type, Silphie (Silphium perforlatium) plants, since, besides the simple and diverse cultivation, the plants can be provided in large amounts as a permanent crop and their fibres are very well suited for paper production due to the composition and mechanical properties. These plant fibres are also sensitive to the mechanical processing on account of the short growth phase and can be processed gently for paper production using the present method of mixed griding.

In accordance with a further alternative embodiment of the present invention, at least one further pulp from one of the two pulp types is admixed to the mixed ground pulp after the grinding.

For the further processing of the previously described board, this is brushed or coated partially or fully on the upper and/or lower side with a sealing lacquer, in particular a hot sealing lacquer, prior to the further processing.

Here, the hot sealing lacquer is also used, as appropriate, for integrally bonded connection of the board, in particular for connection of the side walls and/or the base of a beverage cup.

Here, the sealing lacquer is preferably a synthetic resin dispersion with a milky, liquid appearance, the film properties of which mean that it is flexibly elastic, transparent and suitable for hot sealing, and has a blocking tendency at 40° C. The solids content lies preferably in a range between 45 and 48%, and the viscosity lies in a range measured according to DIN cup 4 mm between 50 and 60 sec. In accordance with a further preferred embodiment, the sealing lacquer has a Cobb 30 min in a range between 4 and 20 g/m², in particular between 4 and 17 g/m², a grease barrier (TAPPI T559 cm/-12) of 7 and a grease barrier (KIT Solvaz) in a range between 1 and 11. The density lies in the region of 1 g/cm³.

A sealing lacquer of this kind is preferably applied using a doctor blade, a doctor bar or by means of a flexographic printing application with an application weight between 4 and 20 g/m² at a temperature between 18 and 25° C. The sealing lacquer is preferably dried by means of IR and/or hot-air drying.

The board is also printed by means of flexographic or offset printing, in particular prior to being processed into a liquid packaging.

The board according to the invention, in particular for the use as a liquid or beverage packaging board, has a surface KIT value of greater than 3, in particular of greater than 6. Due to the method according to the invention for producing the board, this board, in particular for use as a beverage cup, has an advantageous constancy. This means that the properties of the beverage cup remain substantially unchanged when a liquid is received therein, and even in the case of hot liquids (such as tea or coffee) or aggressive liquids (such as Coca-Cola or the like), a constancy of more than 30 minutes is achieved.

It is also included within the scope of the present invention that the board produced by the previously described method and subject as necessary to the additionally described modifications is suitable and used for producing a liquid container, vase, plant pot, beverage container, in particular a beverage cup.

The aforementioned tests and measurement methods were carried out in accordance with the following standards:
surface dimension in g/m² DIN-ISO-536-90,7; thickness in p.m DIN ISO 534 206; volume in cm³/g DIN ISO 534 2,3; longitudinal breaking force in N/15 mm DIN EN 1924/2 52,1; transverse breaking force in N/15 mm DIN EN 1924/232,5; longitudinal elongation in % DIN EN 1924/2 1,3; transverse elongation in % DIN EN1924/22,3; longitudinal wet tensile strength in N/15 mm WS 004 1,0; transverse wet elongation in % Emtec WSD 02 1,40; longitudinal bending force in mN DIN 53121 161; transverse bending force in mN DIN 53121 94; bursting pressure in kPa DIN 53141 145; bursting index in kPam²/g ISO 2758 1,6; air permeability (p=2 mbar) in l/m²s DIN EN ISO 9237; Schopper-Riegler grinding degree test in ° SR DIN ISO 5267-1; Canadian-Standard-Freeness method according to ISO 5267/2; SCAN C21; TAPPI 227; form classification by screening SCAN M 6; TAPPI T 233, 261, UM 239; form classification by opto-electronic measurement methods, such as STFI-splitter analyser, fractionation using classifying devices such as McNett and Clark; classification of the grease impregnation of papers by Tappi T559 (KIT test); water absorption capability as Cobb value (Cobb) according to DIN EN 20 535 to determine the water absorption in g/m².

The method according to the invention will be described hereinafter with reference to an example:

Single-or multi-walled pulp-based cup for cold and hot beverages, recyclable, compostable, free from plastic.

Area density: 35 to 600 g/m²

Use of a formulation formed from fresh fibres and grass

Use of a sealing lacquer (synthetic resin dispersion as described above) with an application weight of 10 g/m².

The sealing lacquer with the used base paper achieves a KIT value>=3

Water absorption behaviour according to Cobb

Board with 250 g/m²: Cobb₁₈₀₀ 85 g/m² Cobb₆₀ 19 g/m²

Board with 300 g/m²: Cobb₁₈₀₀ 68 g/m² Cobb₆₀ 17 g/m²

The board thus produced has the following further properties:
suitable for flanging
asymmetric punch angle inwardly
polymers/emulsion max. 5% (recyclability is thus ensured)
the sealing lacquer can be applied on all sides of the paper and all 4 cutting edges

The following papers were also tested for functionality or employed for the use:
A) GRASSPAPER for cups 300 g/m² #19/4240 with 26/28% grass component with following treatment:
   grease barrier: surface KIT value>6;
   water absorption: Cobb₁₈₀₀=68 g/m² Cobb₆₀=17 g/m²
   water barrier: in the mass;
   water and grease barrier coating on one side with a plant oil emulsion,
   porosity=0;
   aftertreatment: coating is on the outer side of the roll with polymers/emulsion
B) GRASSPAPER for Cups 300 g/m² #19/4211 with 26/28% grass component with following treatment:
   grease barrier: surface KIT value>6;
   water absorption: Cobb₁₈₀₀=68 g/m² Cobb₆₀=17 g/m²
   water barrier: in the mass;
   aftertreatment: treatment on both sides with polymers/emulsion

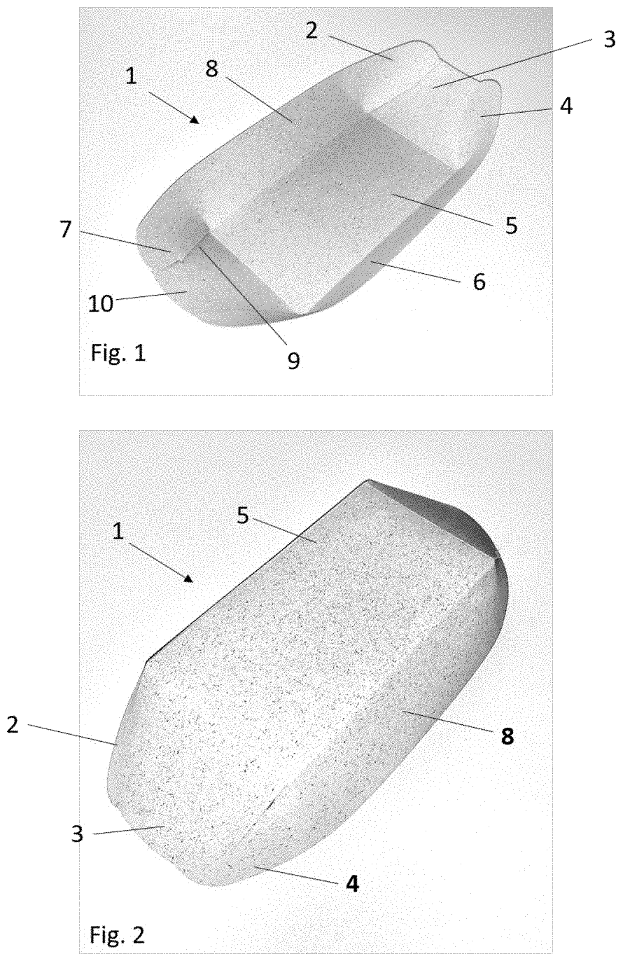

FIGS. 1 and 2 show a practical example for the grass-containing liquid container 1, in which the board according to the invention has been used to produce a bowl for food, in particular moist food. The area density of the board for producing the model was 300 g/m². In FIG. 1, a view from above is shown, and in FIG. 2 a view from below is shown, wherein the base surface 5 is delimited by the side faces 3, 6, 8 and 10. In the overlap regions, of which positions 2, 4 and 7 can be seen in the illustration, the faces have been connected in an integrally bonded manner by means of the used sealing lacquer. This results in a water-resistant bowl form, with a hydrophobic surface, which only experiences water permeability after 4 hours. The edge region of the overlap between the side faces 7 and 10 can also be seen at reference sign 9.

Alternative embodiments, such as coffee cups and the like, can of course also be produced from a corresponding material, wherein here the overlap regions are also connected in an integrally bonded manner using sealing lacquer (for example base and sides in the case of a cylindrical basic form).

The corresponding board was produced as follows:
Pulp composition: grass fibres 30%, long-fibre pulp 70%.
Pulp preparation: 5 minutes swelling of the pulp at 25° C. and continuous mixing and a material density of 5%. Subsequent griding of the pulp using a flat cone refiner and with an energy input of 2000 kW to a degree of dewatering of 55° SR. Addition of 2% cationic starch as additive in the mass and dilution of the pulp suspension to 0.5% material density to produce the board web on a paper machine.
Surface sizing of the board web in an online size press, wherein the size liquor has a material density of 10% and comprises starch and AKD as sizing agent.
Drying of the board web to a residual moisture content of 7%

The corresponding board web was cut in order to produce the food bowl and, prior to folding, was coated with a sealing lacquer in an application amount of 10 g/m², so that the overlap regions were connected in an integrally bonded manner to the sealing lacquer. The food bowl thus produced has a Kit value of 6.3 and can be used both for moist and very moist food. Moisture penetration occurs only in a time period of more than 4 hours. It is particularly advantageous that not only can primary pulp be spared due to the selected pulp composition, but that a fully recyclable or compostable packaging system is provided in comparison to food packaging known from the prior art.

1. A method for producing a grass fibre-containing liquid packaging board having the following steps:
providing a fibre suspension formed from at least a first and second pulp type, wherein the first pulp type is constituted by grass fibres, and
the second pulp type is selected from a group of pulps which comprises primary fibres based on long-fibre wood or short-fibre wood, wood pulp, and synthetic fibres or recycled fibres based on one or more recycled paper classifications,
mixing and/or swelling the fibres in the pulp suspension at a predefined material density and temperature,
grinding the at least two pulp types together, in a pulp suspension to a degree of dewatering between 40° SR and 60° SR,
adding starch and/or a sizing agent as an additive in the mass,
diluting the pulp suspension and producing a board on a paper machine,
surface sizing the board using at least one starch-containing suspension, and
drying the paper structure to a dry content between 4% and 17%.

2. The method according to claim 1, wherein the pulp suspension has a material density between 1% and 10%.

3. The method according to claim 1, wherein the proportion of the first pulp type in the finished board is between 10% and 50%.

4. The method according to claim 1, wherein the proportion of the second pulp type in the finished board is between 90% and 50%.

5. The method according to claim 1, wherein the second pulp is selected from a group of pulps which comprises natural pulps, refiner mechanical pulp (RMP), chemi refiner mechanical pulp (CRMP or CMP) or chemi-thermomechanical pulp (CTMP), pressurised refiner mechanical pulp (PRMP), semi-chemical pulp, high-yield chemical pulp, chemical pulp, alkaline pulp, all of the aforementioned pulps in the form of fresh fibres or also as recycled fibres of the medium or high grades in accordance with EN 643:2001, group 2 or group 3.

6. The method according to claim 1, wherein the second pulp type is a mixture of 10% to 60% short-fibre pulp, and 90% to 40% long-fibre pulp.

7. The method according to claim 1, wherein the mixing and/or the swelling are performed at a predefined material density between 0.1% and 15% over a time between 2 minutes and 10 minutes, and at a temperature between 10° C. and 70° C.

8. The method according to claim 1, wherein the starch is a potato, a maize or a wheat starch.

9. The method according to claim 1, wherein the sizing agent for hydrophobing the cellulose fibres is a resin size, or a synthetic sizing agent, and is combined with a natural or synthetic polymer.

10. The method according to claim 1, wherein the board produced on the paper machine has a mass per unit area between 35 g/m2 and 600 g/m2.

11. The method according to claim 1, wherein the surface sizing is performed with at least one starch suspension, wherein the starch suspension alternatively comprises at least one further additive, which is selected from the group which comprises carboxymethyl cellulose, glyoxal, polymer sizing agent, dry strength agent, wet strength agent, resin size, and synthetic sizing agents.

12. The method according to claim 1, wherein the grinding is performed in a Hollander with a power up to 200 kW, Papillon Refiner with a power between 100 and 3600 kW, a single-disc refiner, a twin-disc refiner, a twin-refiner, a flat cone crusher and/or a steep cone crusher with a power between 90 kW and 2800 kW or a disc mill with a power between 315 kW and 2500 kW.

13. The method according to claim 1, wherein the pulp is dispersed prior to the grinding.

14. The method according to claim 1, wherein the board is smoothed in the paper machine and/or offline by means of a calender, under predefined conditions in respect of the temperature, compressive stress, duration, number of nips, elastic properties of the rollers and the web moisture.

15. The method according to claim 1, wherein the first pulp type is selected from a group which contains spiked grasses, meadow grasses and spiked meadow grasses, as well as sedges of the genera Poaceae and Cyperaceae, grasses of the subfamilies Anomochlooideae, Pharoideae, Puelioideae, Bambusoideae Ehrhartoideae, Pooideae, Tribus Aveneae, Tribus Poeae, Tribus, Triticeae Aristidoideae, Danthonioideae, Arundinoideae, Chloridoideae, Centothecoideae, Panicoideae, Saccharum officinarum and Micrairoideae, and Agrostis canina—velvet bentgrass; Agrostis capillaris—common bent; Agrostis stolonifera—creeping bent; Agrostis vinealis—brown bent; Aira caryophyllea—silver hairgrass; Aira praecox—early hairgrass; Alopecurus geniculatus—water foxtail; Alopecurus myosuroides—slender meadow foxtail; Alopecurus pratensis—meadow foxtail; Ammophila arenaria—marram grass; Anthoxanthum aristatum—awned vernalgrass; Anthoxanthum odoratum—sweet vernalgrass; Apera Spica-venti—lose silky-bent; Arrhenatherum elatius—bulbous oat grass; Avena fatua—common wild oat; Avena sativa—common oat; Brachypodium pinnatum—heath false brome; Brachypodium sylvaticum—false brome; Briza maxima—big quaking grass; Briza media—common quaking grass; Bromus arvensis—field brome; Bromus benekenii—Denver brome; Bromus carinatus—California brome—mountain brome; Bromus erectus—erect brome; Bromus hordeaceus—soft brome; Bromus inermis—awnless brome; Bromus madritensis—compact brome; Bromus secalinus—rye brome; Bromus sterilis—barren brome; Bromus tectorum—downy brome; Calamagrostis arundinacea—reed grass; Calamagrostis epigejos—wood small-reed; Catapodium rigidum—fern-grass; Coix lacryma-jobi—adlay; Cortaderia selloana—pampas grass; Corynephorus canescens—grey hair-grass; Cynodon dactylon—dog's tooth grass; Cynosurus cristatus—rested dog's tail; Dactylis glomerata—cock's foot; Danthonia decumbens—heath grass; Deschampsia cespitosa—tufted hairgrass; Deschampsia flexuosa—wavy hair-grass; Deschampsia setacea—bog hair-grass; Digitaria ischaemum—smooth crabgrass; Digitaria sanguinalis—purple crabgrass; Echinochloa crus-galli—common barnyard grass; Echinochloa muricata—rough barnyard grass; Elymus caninus—bearded couch; Elymus repens—couch grass; Eragrostis albensis—Elbe lovegrass; Eragrostis curvula—weeping lovegrass; Eragrostis minor—small lovegrass; Eragrostis multicaulis—Japanese lovegrass; Festuca arundinacea—tall fescue; Festuca filiformis—fine-leaf sheep fescue; Festuca gigantea—giant fescue; Festuca pratensis—meadow fescue; Festuca rubra—red fescue; Glyceria fluitans—floating sweet-grass; Glyceria maxima—great manna grass; Glyceria maxima—great manna grass; Helictotrichon pratense—meadow oat-grass; Helictotrichon pubescens—downy oat-grass; Helictotrichon pubescens—downy oat-grass; Holcus lanatus—tufted grass; Hordelymus europaeus—wood-barley; Hordeum jubatum—foxtail barley; Hordeum murinum—wall barley; Hordeum vulgare—common barley; Koeleria macrantha—crested hair-grass; Koeleria pyramidata—prairie Junegrass; Lolium multiflorum—Westerwolds ryegrass; Lolium perenne—perennial ryegrass; Lolium remotum—flaxfield ryegrass; Lolium temulentum—darnel ryegrass; Melica ciliata—hairy melic; Melica nutans—mountain melick; Melica uniflora—wood melick; Milium effusum—wood millet; Miscanthus floridulus—Pacific Island silvergrass; Miscanthus sacchariflorus—Amur silvergrass; Miscanthus sinensis—Chinese silvergrass; Miscanthus sinensis ‘Variegatus’—Chinese silvergrass; Miscanthus sinensis ‘Variegatus’—Chinese silvergrass; Molinia arundinacea—Moor grass; Molinia caerulea—purple moor grass; Nardus stricta—matgrass; Panicum capillare—witchgrass; Panicum miliaceum—proso millet; Panicum riparia—panic grass; Pennisetum setaceum—crimson fountain grass; Pennisetum villosum—feathertop grass; Phalaris arundinacea—reed canary grass; Phalaris canariensis—canary grass; Phleum phleoides—Boehmer's cat's tail; Phleum pratense—timothy grass; Phragmites australis—common reed; Poa annua—annual meadow-grass; Poa bulbosa—bulbous bluegrass; Poa chaixii—broad-leaved meadow-grass; Poa compressa—flattened meadow-grass; Poa nemoralis—wood bluegrass; Poa palustris—fowl bluegrass; Poa pratensis—Kentucky bluegrass; Poa trivialis—rough meadow-grass; Polypogon monspeliensis—annual beard-grass; Puccinellia distans—weeping alkaligrass; Secale cereale—rye; Sclerochloa dura—common hardgrass; Setaria italica—foxtail millet; Setaria pumila—yellow foxtail; Setaria verticillata—hooked bristlegrass; Setaria viridis—green foxtail; Sorghum bicolor—sorghum; Sorghum halepense—Johnson grass; Trisetum flavescens—yellow oatgrass; Triticale; Triticum aestivum—common wheat; Triticum dicoccon—Emmer; Triticum durum—durum wheat; Triticum monoccocum—einkorn wheat; Triticum spelta—dinkel wheat; Vulpia myuros—rat's tail fescue; Zea mays—maize, meadow grass, sport and utility grass, Festuca, Lolium perenne, Poa pratensis, Agrosti, sedges of the genus Carex, combinations hereof and the like, and seagrass or algae selected from a group containing Zostera seagrass genera and the species Zostera angustifolia Hornem. Rchb., Zostera asiatica Miki, Zostera caespitosa Miki, Zostera capensis Setch., Zostera capricorni Asch., Zostera caulescens Miki, Zostera japonica Asch. & Graebn., common seagrass Zostera marina L., Zostera mucronata Hartog, Zostera muelleri Irmisch ex Asch., dwarf eelgrass Zostera noltii Hornem., Zostera novazelandica Setch., Zostera tasmanica M. Martens ex Asch., Heterozostera and Phyllospadix, Posidonia Neptune grasses from the Posidoniaceae family, Cymodocea, Halodule, Syringodium and Thalassodendron from the Cymodoceaceae family and Enhalus acoroides, Halophila and Thalassia from the Hydrocharitaceae family, subfamily Halophiloideae, or Glaucophyta, Haptophyta, Cryptista (Cryptophyta), Euglenozoa, Dinozoa s. Dinoflagellates, Raphidophyceae Chloromonadophyceae, Chlorarachniophyta, yellow-green algae Xanthophyceae, golden algae (Chrysophyta), Bacillariophyta diatoms, Phaeophyta brown algae, Rhodophyta red algae, Chlorophyta green algae, Picobiliphyta, Heterokontophyta, Excavata, Stramenopile, Haptophyta, Cryptophyta, Chlorarachniophyta and Heterokontophyta, Alveolata, Biliphyta, combinations hereof and the like.

16. The method according to claim 1, wherein the first pulp type is Silphie (Silphium perfolatium).

17. The method according to claim 1, wherein at least one further pulp from one of the two pulp types is admixed to the mixed ground pulp after the grinding.

18. The method according to claim 1, wherein the board is brushed or coated partially or fully on the upper side and/or lower side with a sealing lacquer prior to production of the liquid packaging.

19. The method according to claim 18, wherein the sealing lacquer is applied with a weight per unit area between 5 and 15 g/m2.

20. The method according to claim 18, wherein the sealing lacquer is a hot sealing lacquer used for integrally bonded connection of the board.

21. The method according to claim 1, wherein the board is printed by flexographic or offset printing.

22. The method according to claim 1, wherein the board has a surface KIT value of greater than 3.

23. Use of a board which is produced by the method of claim 1 for production of a liquid container, a vase, a plant pot, a beverage container, or a beverage cup.
